(19) United States
(12) Patent Application Publication
(10) Pub. No.: US 2015/0130097 A1
(43) Pub. Date: May 14, 2015

(54) METHOD FOR MANUFACTURING AN ANTIMICROBIAL FILAMENT FIBRE AND METHOD FOR MANUFACTURING AN ANTIMICROBIAL FABRIC

(71) Applicant: JENELL-TEX INT'L CO., LTD., Taoyuan City (TW)

(72) Inventor: Chih-Yu Chang, Taoyuan City (TW)

(73) Assignee: JENELL-TEX INT'L CO., LTD., Taoyuan City (TW)

(21) Appl. No.: 14/109,489

(22) Filed: Dec. 17, 2013

(30) Foreign Application Priority Data
Nov. 8, 2013 (TW) 102140594

(51) Int. Cl. B29C 47/00; D04H 13/00; B29D 99/00

(52) U.S. Cl. CPC B29C 47/0014; B29D 99/0078; D04H 13/00; B29K 2101/12
USPC 264/13; 264/103

(57) ABSTRACT

A method for manufacturing an antimicrobial filament fibre includes the following steps of: mixing diiodomethyl p-tolyl sulfone with a plastic mother particle so that the particle contains diiodomethyl p-tolyl sulfone; and melt-spinning the particle to form the antimicrobial filament fibre.

### CROSS REFERENCE

The non-provisional application claims priority from Taiwan Patent Application NO. 102140594, filed on Nov. 8, 2013, the content thereof is incorporated by reference herein.

### FIELD OF THE INVENTION

The invention is directed to a method for manufacturing an antimicrobial filament fibre, and a method for manufacturing an antimicrobial fabric.

### BACKGROUND OF THE INVENTION

Diiodomethyl p-tolyl sulfone (DIMPTS) is a well-known antimicrobial agent. Nowadays, this antimicrobial agent is commonly in the form of a liquid solution, and optionally sprayed to the environment or coated on a substance with the purpose of eliminating or fighting against pathogens. For instance, this antimicrobial agent is sprayed to our clothes so that the clothes possess the antimicrobial function. However, neither this spraying nor this coating make this antimicrobial agent provide the environment and the substance with long-term antimicrobial function. Therefore, it is desired to develop a manufacturing method which can keep diiodomethyl p-tolyl sulfone maintained on a substance for a long term so as to give the substance long-term antimicrobial function.

### SUMMARY OF THE INVENTION

An object of the invention is to provide a manufacturing method, and the method can maintain diiodomethyl p-tolyl sulfone on a substance, especially a textile. In such a way, the substance has long-term antimicrobial function.

For the foregoing and/or other object, a method for manufacturing an antimicrobial filament fibre is disclosed, and the method includes the following steps of: mixing diiodomethyl p-tolyl sulfone with a plastic mother particle so that the particle contains diiodomethyl p-tolyl sulfone; and melt-spinning the particle to form the antimicrobial filament fibre.

### BRIEF DESCRIPTION OF THE DRAWINGS

FIG. 1 is a flow chart illustrating a method for manufacturing an antimicrobial fabric in accordance with an embodiment of the invention.

### DETAILED DESCRIPTION OF THE INVENTION

The detailed description and preferred embodiment of the invention will be set forth in the following content, and provided for people skilled in the art so as to understand the characteristic of the invention.

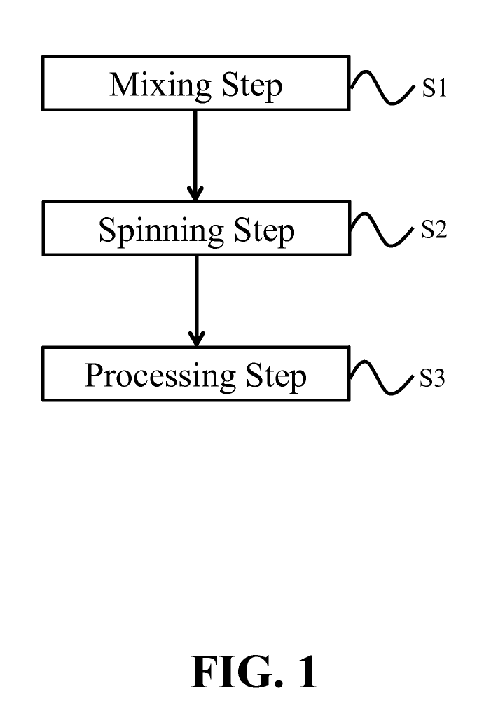

A method for manufacturing an antimicrobial fabric in accordance with an embodiment of the invention is depicted in FIG. 1, and the method at least includes a mixing step S1, a spinning step S2, and a processing step S3.

Firstly, in the step S1, diiodomethyl p-tolyl sulfone is mixed with a plastic mother particle so that the particle contains diiodomethyl p-tolyl sulfone. An example of the plastic mother particle is variously dependent on the subsequent use of the fabric, and the example is, but not limited to, a nylon mother particle, a polyethylene mother particle, a polypropylene mother particle, or a polyester mother particle.

Then, in the step S2, the plastic mother particle is melt-spun to form an antimicrobial filament fibre. More specifically, during this step, the plastic mother particle is melted into a molten state, the plastic mother particle is extruded through a capillary hole to form a filament fibre precursor, and then the precursor is cooled to form the antimicrobial filament fibre.

Finally, in the step S3, a process is applied to the antimicrobial filament fibre to form the antimicrobial fabric. Generally, the way of the process can determine the form of the antimicrobial fabric. In an example, while the process is a fancy yarn process, the fabric is a fancy yarn. In another example, while the process is an air-splicing process, the fabric is an air-textured yarn (ATY). In yet another example, while the process is a false-twisting process, the fabric is a draw-textured yarn (DTY).

It is noted that reaction conditions of all the steps are not particularly limited, as long as the purpose of these steps can be achieved. Further, these reaction conditions can be easily introduced by people skilled in the art with reference to this content.

As above, the filament fibre and the fabric are produced via a serious of these steps. In such a manner, the antimicrobial agent diiodomethyl p-tolyl sulfone is contained in these products for a long term, and further provides these products with long-term antimicrobial function. According to the foregoing advantage(s), the embodiment is indeed a breakthrough for textile industry.

While the invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A method for manufacturing an antimicrobial filament fibre, comprising:
mixing diiodomethyl p-tolyl sulfone with a plastic mother particle so that the particle contains the diiodomethyl p-tolyl sulfone; and
melt-spinning the particle to form the antimicrobial filament fibre.

2. The method as claimed in claim 1, wherein the plastic mother particle is selected from the group consisting of a nylon mother particle, a polyethylene mother particle, a polypropylene mother particle, and a polyester mother particle.

3. The method as claimed in claim 1, wherein the melt-spinning step comprises:
melting the plastic mother particle into a molten state;
extruding the plastic mother particle through a capillary hole to form a filament fibre precursor; and
cooling the filament fibre precursor to form the antimicrobial filament fibre.

4. A method for manufacturing an antimicrobial fabric, comprising:
mixing diiodomethyl p-tolyl sulfone with a plastic mother particle so that the particle contains the diiodomethyl p-tolyl sulfone;
melt-spinning the particle to form an antimicrobial filament fibre; and
applying a process to the antimicrobial filament fibre to form the antimicrobial fabric.

5. The method as claimed in claim 4, wherein the plastic mother particle is selected from the group consisting of a nylon mother particle, a polyethylene mother particle, a polypropylene mother particle, and a polyester mother particle.

6. The method as claimed in claim 4, wherein the melt-spinning step comprises:
melting the plastic mother particle into a molten state;
extruding the plastic mother particle through a capillary hole to form a filament fibre precursor; and
cooling the filament fibre precursor to form the antimicrobial filament fibre.

7. The method as claimed in claim 4, wherein the process is selected from the group consisting of a fancy yarn process, an air-splicing process, and a false-twisting process.
